(19) United States
(12) Patent Application Publication
(10) Pub. No.: US 2002/0003769 A1
(43) Pub. Date: Jan. 10, 2002

(54) Near-field optical head

(75) Inventors: Minoru Yamada, Kanazawa City (JP); Mitsuru Kinouchi, Chuo-ku (JP)

Correspondence Address: OLIFF & BERRIDGE, PLC, P.O. BOX 19928, ALEXANDRIA, VA, 22320, US

(73) Assignee: TDK Corporation

(21) Appl. No.: 09/812,997

(22) Filed: Mar. 21, 2001

(30) Foreign Application Priority Data
Mar. 23, 2000 (JP) 2000-081580

(51) Int. Cl. G11B 7/00

(52) U.S. Cl. 369/121; 369/118

(57) ABSTRACT

An optical head including a distributed feedback laser having first and second cladding layers, an active layer sandwiched between said first and second cladding layers, a first reflecting member having a periodic wave-shaped structure formed within said first cladding layer at an interface between said active layer and said first cladding layer or in close proximity to said active layer, a second reflecting member provided on a first end surface of an assembly of said first and second cladding layer and active layer and having an exit window formed by a fine aperture, a third reflecting member provided on a second end surface of said assembly, and first and second current injection electrodes electrically connected to said first and second cladding layers, respectively as well as to an injection current source for injecting a current modulated in accordance with information to be recorded on the optical record medium into the laser. Laser light emitted from said exit window of the distributed feedback laser is made incident upon the optical record medium arranged in a near-field to record the information with a high density.

### Background of the Invention

1. Field of the Invention

The present invention relates to an optical head for recording and/or reproducing information on and/or from an optical record medium, and more particularly to a near-field optical head for realizing an extremely high record density by using near-field light.

2. Description of the Related Art

In conventional optical heads, laser light emitted from a semiconductor laser is made incident upon an optical record medium such as optical disk to change a property of a material of the optical record medium thermally. Upon reproducing, laser light emitted from a semiconductor laser is made incident upon the optical record medium and a variation in intensity or polarization plane of reflected light is detected by a photodetector. A recording density of information on the optical record medium is determined by a beam size of the laser light confined by an objective lens, and could not be reduced smaller than a half of a wavelength of laser light (λ/2) due to the diffraction limit to resolution. Moreover, the semiconductor laser and photodetector are formed as separate elements, and therefore size and weight of the optical head are liable to be large, and a cost of the optical head is increased due to an increase in the number of parts of the optical head. Furthermore, at most a quarter of energy of the laser light emitted from the semiconductor laser is returned onto the photodetector, and thus a reproduced signal has a very small SIN.

In order to solve the above mentioned problems, Japanese Patent Application Laid-open Publications Nos. 9-145603 and 10-255302 propose new type optical heads using near-field light. This type optical head is based on the fact that light component called near-field light is existent in close proximity to a light exit area, and information can be recorded and reproduced for an extremely fine region smaller than a half wavelength by utilizing the near-field light.

When light is made incident upon a semiconductor laser, a voltage across current injection electrodes of the laser is changed. Based on this fact, there have been proposed optical heads in which a semiconductor laser per se is used as a photodetector. For instance, in Japanese Patent Application Laid-open Publications Nos. 57-13353 1 and 63-74128, such optical heads are proposed. In such optical beads, 100% of laser light emitted from a semiconductor laser is returned into the semiconductor laser.

As explained above, a new optical head utilizing both the near-filed light generated in close proximity to an exit of a semiconductor laser and the photodetection by the semiconductor laser itself in combination has been studied. However, in order to reduce a beam size of laser light emitted from the semiconductor laser, it is necessary to reduce a size of an exit window of the semiconductor laser, and therefore an amount of the laser beam emitted from the semiconductor laser is limited. Then, it is no more difficult to record information on an optical record medium accurately. In this manner, the reduction of a beam size of the laser light is limited, and a record density could not be increased.

Furthermore, when the laser light is made incident upon the semiconductor laser, the operation of the semiconductor laser becomes unstable, and there is produced rather large noise called return light noise. This is discussed in detail in, for instance T. Morikawa et al., “Electronics Letters”, Vol. 12, p. 435, 1976. When such a large return light noise is produced, the photodetection could not be carried out precisely and information recorded on the optical record medium could not be reproduced accurately.

### SUMMARY OF THE INVENTION

The present invention has for its object to provide a novel and useful near-field optical head, in which the above mentioned problems of the known optical heads can be removed or at least can be mitigated, the record density can be increased by reducing a beam size sufficiently, and information can be recorded accurately with a sufficiently large amount of laser light.

It is another object of the invention to provide a near-field optical head, in which a semiconductor laser can operate stably without being affected by return light and information recorded on an optical record medium can be read out accurately.

It is still another object of the invention to provide a near-field optical bead, in which the reproduction of information can be performed by utilizing effectively energy of laser light emitted from a semiconductor laser even when a photodetector is provided separately from the semiconductor laser.

According to the invention, a near-field optical head comprises:

a distributed feedback laser including first and second cladding layers, an active layer sandwiched between said first and second cladding layers, a first reflecting member having a periodic wave-shaped structure formed within said first cladding layer at an interface between said active layer and said first cladding layer or in close proximity to said active layer, a second reflecting member provided on a first end surface of an assembly of said first and second cladding layer and active layer and having an exit window formed by a fine aperture, and a third reflecting member provided on a second end surface of said assembly; and

first and second current injection electrodes electrically connected to said first and second cladding layers, respectively; and

an injection current source connected to said first and second current injection electrodes;

whereby laser light emitted from said exit window of the distributed feedback laser is made incident upon an optical record medium arranged in a near-field.

The near-field optical head according to the invention may be constructed as a recording optical head for recording information on an optical record medium. In such a recording optical head, a current injected into the distributed feedback laser by means of said first and second current injection electrodes is modulated in accordance with information to be recorded on the optical record medium, and near-field laser light having modulated intensity is made incident upon the optical record medium to cause a thermal change in a material of the optical record medium.

It should be noted that the near-field optical head according to the invention may be constructed as a reproducing optical head for reading information out of an optical record medium. In a preferable embodiment of such a reproducing optical head according to the invention, a constant current is injected into the distributed feedback laser to produce near-field laser light having a constant intensity, and this near-field laser light is made incident upon the optical record medium. Laser light reflected by the optical record medium is returned into the distributed feedback laser through said exit window. Then, a voltage across said first and second current injection electrodes is changed in accordance with the information recorded on the optical record medium. Therefore, by detecting the voltage change, it is possible to reproduce the information recorded on the optical record medium. The near-field optical head according to the invention may be constructed to have a function of both the recording head and the reproducing head.

In another preferable embodiment of the near-field optical head according to the invention constructed as the reproducing optical head, the constant current is injected in to the distributed feedback laser, near-field laser light having a constant intensity is made incident upon the optical record medium, the laser light reflected by the optical record medium is returned into the distributed feedback laser by means of the exit window and is amplified therein, and laser light emanating from said third reflecting member is received by a photodetector to produce a reproduction signal of information recorded on the optical record medium. Also the near-field optical head of this embodiment may be constructed as the recording and reproducing optical head by adding the function of the above mentioned recording optical head.

In the near-field optical head according to the invention, said second reflecting member may be preferably formed by a dielectric film provided on the first end surface of the assembly of the cladding layers and active layer, and a metal film applied on the dielectric film and having formed therein a fine opening constituting the exit window. In this case, the dielectric film provided under the metal film serves to perform the electrical insulation and to increase a light emitting efficiency. The third reflecting member provided on the opposite end surface of the assembly of the cladding layers and active layer may be preferably formed by multiple films of dielectric materials.

### BRIEF DESCRIPTION OF THE DRAWINGS

FIG. 1 is a schematic cross sectional view showing a first embodiment of the near-field optical head according to the invention;

FIG. 2 is a schematic cross sectional view depicting a second embodiment of the near-field optical head according to the invention;

FIG. 3 is a cross sectional view illustrating schematically a third embodiment of the near-field optical head according to the invention; and

FIG. 4 is a graph representing a detection sensitivity of the second embodiment of the near-field optical head according to the invention in comparison with the Fabry Perot resonator.

### DESCRIPTION OF THE PREFERRED EMBODIMENTS

Now the present invention will be explained in detail with reference to several embodiments shown in the accompanying drawings.

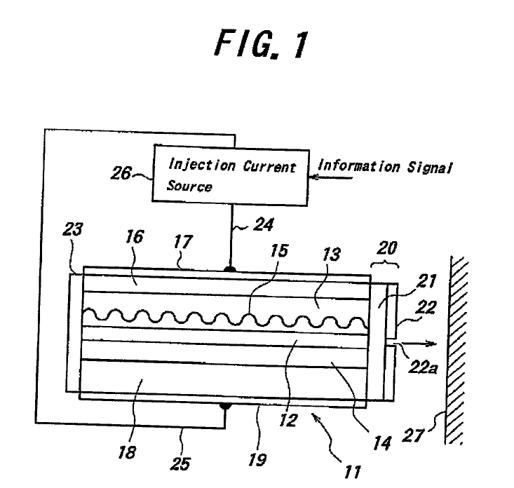

FIG. 1 is a schematic cross sectional view showing an embodiment of the near-field optical head according to the invention. The near-field optical head of the present embodiment is constructed as the recording optical head. The optical head comprises a distributed feedback laser (DFB laser) 11. The DFB laser 11 comprises an active layer 12 having double-hetero structure or quantum-well structure or distortion quantum-well structure. The active layer 12 is sandwiched between first and second cladding layers 13 and 14.

According to the invention, in the first cladding layer 13 there is formed a first reflecting member 15 having a periodic wave-shaped structure which situates in close proximity to the active layer 13. The active layer 12 and cladding layers 13, 14 are made of III-V or II-VI compound semiconductor materials. In the present embodiment, the first reflecting member including the periodic wave-shaped structure is formed in the first cladding layer 13 in close proximity to the active layer 12, but according to the invention the first reflecting layer may be formed in an interface between the active layer 12 and the first cladding layer 13.

On the first cladding layer 13 is provided a electrode connecting layer 16 having a low resistance and a first electrode 17 is formed on this electrode connecting layer 16. An assembly of the active layer 12, first and second cladding layers 13 and 14 and electrode connecting layer 16 is provided on one surface of a substrate 18, and a second electrode 19 is provided on the other surface of the substrate 18. In the present embodiment, the substrate 18 and second cladding layer 14 are made of n type semiconductor material, the active layer 12 is made of an intrinsic semiconductor material, and the first cladding layer 13 and electrode connecting layer 16 are made of p type semiconductor material.

The DFB laser 11 further comprises a first reflecting member 20 and a second reflecting member 23 provided on opposite end surfaces of the assembly of the semiconductor layers. The second reflecting member 20 includes a dielectric film 21 for performing the electrical insulation and increasing a light exit efficiency, and a metal film 22 for preventing undesired light emission and returning light into the laser efficiently. 4t a center of the metal film 22 there is formed a fine opening which defines an exit window 22a. The exit window 22a may be formed to have a diameter within a range from about λ/100 to about λ. The third reflecting member 23 provided on the end surface opposite to the exit end surface is formed by multiple dielectric films in order to attain an optimum reflectance.

The current injection electrodes 17 and 19 electrically connected to the first and second cladding layers 13 and 14, respectively are connected to an injection current source 26 by means of conductors 24 and 25, respectively. By injecting the current into the DFB laser 11 from the injection current source 26 to flow a current from the electrode 17 to the electrode 19, the DFB laser 11 can be oscillated. When the substrate 18 and second cladding layer 14 are made of p type semiconductor materials and the first cladding layer 13 and electrode connecting layer 16 are made of n type semiconductor materials, the current flows in an opposite direction.

In the present embodiment, information is recorded on an optical record medium 27 which is arranged in opposition to the exit window 22a formed in the second reflecting member 20 of the DFB laser 11. For sake of clarity, a distance between the exit window 22a and the optical record medium 27 is shown to be large, but in a practical device, this distance is to be substantially identical with a diameter of the exit window. That is to say, the optical record medium 27 is arranged in close proximity to the exit window 22a such as within a range from about λ/100 to about λ. An information signal is supplied to the injection current source 26 to change a magnitude of the current injected into the DFB laser 11 in accordance with the information signal. Then, an intensity of the near-field light emitted from the exit window 22a of the DFB laser is changed in accordance with the information. When the near-field light whose intensity is modulated in accordance with the information to be recorded is made incident upon the optical record medium 27, a material of the optical record medium is changed thermally, In this manner, the information can be recorded on the optical record medium 27 with an extremely high density.

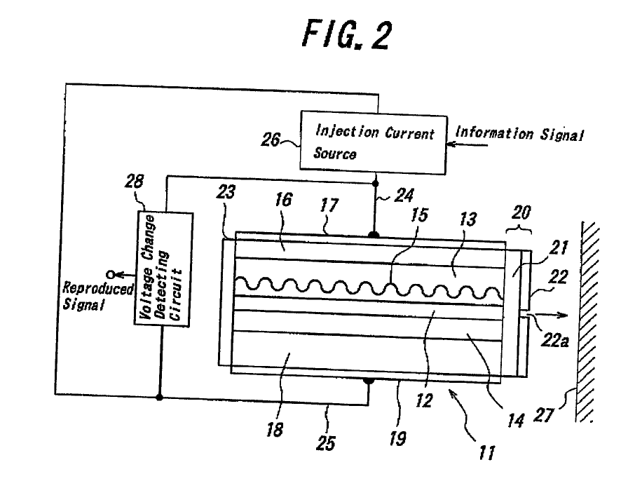

FIG. 2 is a cross sectional view illustrating schematically a second embodiment of the near-field optical head according to the invention. In the present embodiment, portions similar to those of the previous embodiment are denoted by the same reference numerals used in FIG. 1 and their detailed explanation is dispensed with. The near-field optical head of the present embodiment is constructed as recording and reading optical head, in which information can be recorded on an optical record medium with a high density and the thus recorded information can be read out accurately. The recording operation is identical with that of the previous embodiment shown in FIG. 1. That is to say, the current injected into the DFB laser 11 from the injection current source 26 is modulated in accordance with the information signal, and the near-filed light whose intensity is modulated in accordance with the information signal is made incident upon the optical record medium 27 arranged in close proximity to the DFB laser through the exit window 22a to give the thermal change in the material of the optical record medium.

Upon reading the information out of the optical record medium 27, a constant current is injected from the injection current source 26 into the DFB laser 11, and near-field light having a constant intensity is made incident upon the optical record medium 27 by means of the exit window 22a. Light reflected by the optical record medium is modulated in accordance with the information recorded on the optical record medium and is made incident upon the DFB laser through the exit window 22a. Then, an oscillation threshold level of the DFB laser 11 is changed in accordance with the return light, and the number of photons within the laser is changed. This results in that the voltage across the electrodes 17 and 19 is changed, and this voltage change is detected by a voltage change detecting circuit 28 to produce a reproduction signal representing the information read out of the optical record medium 27.

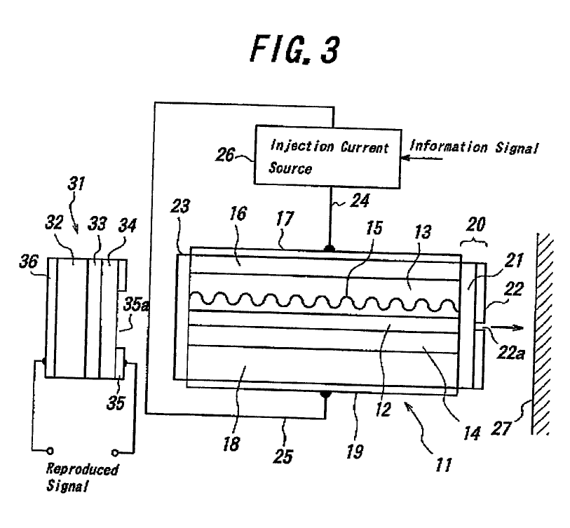

FIG. 3 is a schematic cross sectional view showing a third embodiment of the near-field optical head according to the invention. The near-field optical head of this embodiment is also constructed as the recording and reading optical head like as the second embodiment. However, in the present embodiment, a photodetector 31 is arranged behind the third reflecting member 23 of the DFB laser 11. The light reflected by the optical record medium 26 is returned into the DFB laser 11 and is amplified therein. The amplified light emanates from the third reflecting member 23 and is made incident upon the photodetector 31. In this manner, the photodetector 31 produces the reproduced signal.

The photodetector 31 comprises a substrate 32 made of IV semiconductor material or III-V or II-VI compound semiconductor material, a light absorbing layer 33 formed on one surface of the substrate and a cap layer 34 formed on the absorbing layer. On the cap layer 34, is provided an electrode 35 having an entrance window 35a formed therein. An electrode 36 is provided on the other surface of the substrate 32. It should be noted that the photodetector 31 having the above mentioned structure is known, and any other photodetectors may be used in the present invention.

In case of reproducing the information recorded on the optical record medium 27, a constant injection current is supplied from the injection current source 26 into the DFB laser 11 to emit the laser light having a constant intensity from the exit window 22a formed in the second reflecting member 22. The laser light is made incident upon the optical record medium 27 arranged in the near-field of the exit window. The laser light is then modulated in accordance with the information recorded on the optical record medium 27, and is reflected by the optical record medium. The thus reflected laser light is returned into the DFB laser 11 through the exit window 22a. Due to this return light, the laser oscillation threshold current is changed as stated above, and the number of photons within the laser is changed. Therefore, an intensity of the laser light emanating from the third reflecting member 23 is also changed in accordance with the information recorded on the optical record medium 27. In this manner, the laser light amplified by the DFB laser 11 and modulated in accordance with the information is made incident upon the photodetector 31 to generate the reproduction signal representing the information with an extremely high sensitivity.

Now an example of calculation for the second embodiment shown in FIG. 2 will be explained. The active layer 12 of the DFB laser 11 is made of GaAs, the first and second cladding layers 13 and 14 are made of AlGaAs, and a resonator length L defined by a distance between the second reflecting member 20 and the third reflecting member 23 is set to 150 μm. The period of the periodic wave-shaped structure of the first reflecting member 15 is set such that laser light having a wavelength λ=0.855 μm is generated.

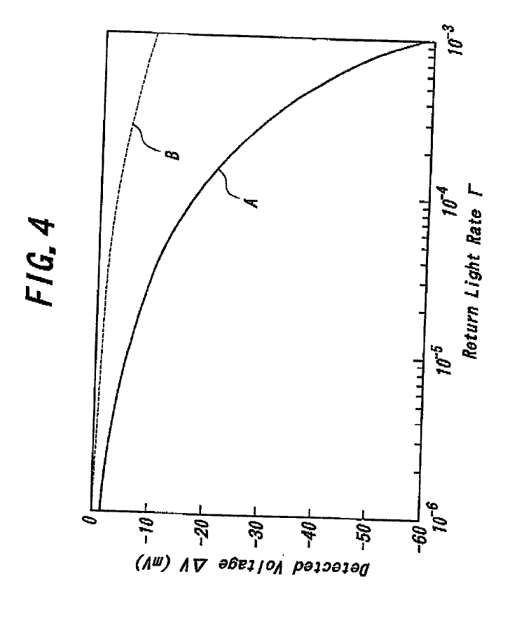

FIG. 4 is a graph representing the detection sensitivity of the DFB laser 11 formed in the manner explained above. In this graph, a horizontal axis denotes a total return light ratio Γ and a vertical axis denotes a voltage change ΔV (mV) detected by the voltage change detecting circuit 28 which detects a voltage change between the electrodes 17 and 19 of the DFB laser 11. The total return light ratio represents a ratio of an amount of laser light which is reflected by the optical record medium 27, is returned into the DFB laser 11 and is combined with light within the laser with respect to a total amount of the laser light emanating from the exit window 22a.

In FIG. 4, a curve A represents the detection sensitivity of the near-field optical bead according to the invention, in which a reflection factor KL due to the periodic wave-shaped structure of the first reflecting member 15 within the laser is set to 3, an electric power reflectance R_{b} of the third reflecting member 23 is set to 0.0, and the electric power reflectance R_{f} of the second reflecting member 20 is set to 0.95. It should be noted that a configuration, i.e. a phase of the period wave-shaped structure of the first reflecting member 15 is optimized at an interface between the first reflecting member 15 and the second and third reflecting members 20 and 23 such that an absolute value of the detection voltage becomes maximum.

A curve B in FIG. 4 represents the detection sensitivity of a comparative optical head including a conventional Fabry Perot resonator, in which reflection mirrors are provided on front and rear end surfaces and the period wave-shaped structure is not provided. In this case, R_{b} is set to 0.5 and Rf is set to 0.95. Both in the curves A and B, the threshold currents for the laser oscillation are substantially identical with each other.

As can be understood from the graph shown in FIG. 4, the detection sensitivity of the optical head according to the invention comprising the periodic wave-shaped structure is larger than that of the optical head without such wave-shape structure by about six times. A reason of such a high detection sensitivity could not be explained completely, but could be assumed as follows.

In a proximity of the exit window 22a of the second reflecting member 20 of the DFB laser 11, light reflected by the metal film 22 and return light from the optical record medium 27 are combined with each other and the thus combined light is returned into the laser, When these light components have a same phase, intensity is increased, but when opposite phase, intensity is weakened. In the Fabry Perot resonator, there are produced a plurality of resonator longitudinal modes, and the resonator oscillates at a mode having a minimum threshold value irrespective of the existence of return light.

When the periodic wave-shaped structure is provided, only one longitudinal oscillation mode is selected. Furthermore, a complex resonator is constructed by the first reflecting member 15 including the periodic wave-shaped structure and the second and third reflecting members 20 and 23. Therefore, the oscillation threshold value is changed with an extremely high sensitivity in accordance with various factors such as the reflectance R_{b} of the multiple dielectric films of the third reflecting member 23, configurations (phase) of the second and third reflecting members 20 and 23 at interfaces between these reflecting members and the periodic wavesbaped structure of the first reflecting member 15, an optical thickness of the dielectric film 21 of the second reflecting member 20, the reflectance R_{f} of the metal film 22 and a phase of the return light. Therefore, upon detecting the existence of the return light and the variation in the intensity of the return light as a change in voltage across the electrodes 17 and 19, the detection sensitivity can be increased by optimizing the construction of the DFB laser including the periodic wave-shaped structure and the phase relationship.

The above explained function may be equally obtained in the second embodiment of the optical head according to the invention shown in FIG. 2, in which the laser light reflected by the optical record medium 27 is returned into the DFB laser 11 by means of the exit window 22a, the return laser light is amplified by the laser, and the amplified laser light emanating from the third reflecting member 23 is received by the photodetector 31 arranged separately from the DFB laser 11. In this embodiment, the conductors 24 and 25 for conducting the injection current to the DFB laser 11 are electrically isolated from the output terminals generating the reproduced signal, and therefore much more stable laser operation can be attained.

The present invention is not limited to the embodiments explained above, but many alternations and modifications may be conceived by a person skilled in the art within the scope of the invention. For instance, the DFB laser 11 is not limited to the structure shown in the drawings, but may have various configurations. In the above embodiments, the period wave-shaped structure of the first reflecting member 15 has a smooth wave configuration, but it may be formed to have a rectangular or triangular crenellated configuration. In this connection, it should be noted that when a periodic structure having any configuration is subjected to the Fourier expansion with a trigonometric function, a wave-shaped component has a meaning for the distributed feedback (DFB) operation. Therefore, in the present specification, such a periodic structure is called the periodic wave-shaped structure.

As explained above in detail, in the near-field optical head according to the invention, use is made of the distributed feedback laser 11 including the first reflecting member 15 having the periodic wave-shaped structure, the second reflecting member 20 provided on the front end surface and having the exit window 22a formed by the fine aperture, and the third reflecting member 23 provided on the rear end surface, and the near-field laser light emanating from the exit window 22a is made incident upon the optical record medium 27 arranged in the near-field of the exit window. Therefore, the laser can operate stably even under the return light, and the information can be recorded with an extremely high density. Upon the reproduction, the near-field laser light reflected by the optical record medium 27 is returned into the DFB laser via the exit window 22a. Then, the oscillation threshold value is changed, and thus the number of photons within the laser is changed accordingly. Therefore, the voltage across the current injection electrodes 17 and 19 is changed, and this voltage change is directly detected by the voltage change detecting circuit 28 to produce the reproduced signal. In the other embodiment, the return laser light is amplified in the laser, and the thus amplified laser light emanating from the third reflecting member 23 is received by the photodetector 31 arranged separately from the DFB laser. In this manner, the information recorded on the optical record medium 27 with the high density can be read out with a high sensitivity.

What is claimed is:

1. A near-field optical head comprising:
a distributed feedback laser including first and second cladding layers, an active layer sandwiched between said first and second cladding layers, a first reflecting member having a periodic wave-shaped structure formed within said first cladding layer at an interface between said active layer and said first cladding layer or in close proximity to said active layer, a second reflecting member provided on a first end surface of an assembly of said first and second cladding layer and active layer and having an exit window formed by a fine aperture, a third reflecting member provided on a second end surface of said assembly, and first and second current injection electrodes electrically connected to said first and second cladding layers, respectively; and
an injection current source connected to said first and second current injection electrodes;
whereby laser light emitted from said exit window of the distributed feedback laser is made incident upon an optical record medium arranged in a near-field.

2. The near-field optical head according to claim 1, wherein said periodic wave-shaped structure of the first reflecting member has a smooth wave configuration.

3. The near-field optical head according to claim 1, wherein said second reflecting member includes a dielectric film provided on the first end surface of the assembly of the first and second cladding layers and active layer, and a metal film formed on the dielectric film and having formed therein said fine aperture constituting said exit window.

4. The near-field optical head according to claim 1, wherein said third reflecting member is formed by multiple dielectric films.

5. The near-field optical bead according to claim 1, wherein the near-field optical head is constructed as a recording optical head for recording information on an optical record medium.

6. The near-field optical head according to claim S, wherein a current injected into the distributed feedback laser by means of said first and second current injection electrodes from said injection current source is modulated in accordance with information to be recorded on the optical record medium, and near-field laser light having modulated intensity is made incident upon the optical record medium to cause a thermal change in a material of the optical record medium.

7. The near-field optical head according to claim 1, wherein the near-field optical head is constructed as a reproducing optical head for reproducing information recorded on the optical record medium.

8. The near-field optical head according to claim 7, wherein a constant current is injected into the distributed feedback laser from said injection current source to produce near-field laser light having a constant intensity, the thus produced near-field laser light is made incident upon the optical record medium through said exit window, laser light reflected by the optical record medium is returned into the distributed feedback laser through said exit window, and a voltage change appearing across said first and second current injection electrodes is detected to produce a reproduced signal representing the information recorded on the optical record medium.

9. The near-field optical head according to claim 7, wherein a constant current is injected into the distributed feedback laser to produce near-field laser light having a constant intensity, the thus produced near-field laser light having a constant intensity is made incident upon the optical record medium, and laser light reflected by the optical record medium is returned into the distributed feedback laser by means of the exit window and is amplified therein; whereby the near-field optical head further comprises a photodetector for receiving laser light emanating from said third reflecting member to produce a reproduction signal representing the information recorded on the optical record medium.

10. The near-field optical head according to claim 1, wherein the near-field optical head is constructed as a recording and reproducing optical head for recording information on the optical record medium and reproducing the information from the optical record medium.

11. The near-field optical head according to claim 10, wherein
upon recording the information on the optical record medium, a current injected into the distributed feedback laser by means of said first and second current injection electrodes from said injection current source is modulated in accordance with information to be recorded on the optical record medium, and near-field laser light having modulated intensity is made incident upon the optical record medium to cause a thermal change in a material of the optical record medium; and
upon reproducing the information from the optical record medium, a constant current is injected into the distributed feedback laser from said injection current source to produce near-field laser light having a constant intensity, the thus produced near-field laser light is made incident upon the optical record medium through said exit window, laser light reflected by the optical record medium is returned into the distributed feedback laser through said exit window, and a voltage change appearing across said first and second current injection electrodes is detected to produce a reproduced signal representing the information recorded on the optical record medium.

12. The near-field optical head according to claim 10, wherein the near-field optical head further comprises a photodetector; and
upon recording the information on the optical record medium, a current injected into the distributed feedback laser by means of said first and second current injection electrodes from said injection current source is modulated in accordance with information to be recorded on the optical record medium, and near-field laser light having modulated intensity is made incident upon the optical record medium to cause a thermal change in a material of the optical record medium; and
upon reproducing the information from the optical record medium, a constant current is injected into the distributed feedback laser to produce near-field laser light having a constant intensity, the thus produced near-field laser light having a constant intensity is made incident upon the optical record medium, laser light reflected by the optical record medium is returned into the distributed feedback laser by means of the exit window and is amplified therein, and laser light emanating from said third reflecting member is detected by said photodetector to produce a reproduction signal representing the information recorded on the optical record medium.
